(19) United States
(12) Patent Application Publication
(10) Pub. No.: US 2022/0092711 A1
(43) Pub. Date: Mar. 24, 2022

(54) SYSTEM AND METHOD FOR EXTRACTING DATA FROM CONTRACTS USING AI BASED NATURAL LANGUAGE PROCESSING (NLP)

(71) Applicant: SimpliContract Technologies Private Limited, Bangalore (IN)

(72) Inventors: Gururaman Venkatesan, Bangalore (IN); Jinaraj Patinjakkara Gopalan, Bangalore (IN); Makeshkumar Manoharan, Vridhachalam (IN)

(21) Appl. No.: 17/475,265

(22) Filed: Sep. 14, 2021

(30) Foreign Application Priority Data
Sep. 15, 2020 (IN) 202041035209

(51) Int. Cl. G06Q 50/18

(52) U.S. Cl. CPC G06Q 50/18

(57) ABSTRACT

Disclosed is a method for extracting data from contracts using a contract data extraction system. The method includes following steps of: obtaining a contract from which the data to be extracted; processing the contract to identify one or more sections of the contract; scanning for data within the identified one or more sections of the contract; and identifying and extracting the data from the corresponding one or more sections of the contract using natural language processing (NLP). The one or more sections include at least one of clauses, obligations, signature and tabular data. The one or more sections are identified using a predefined library. The identified one or more sections are demarcated by matching with the predefined library. The identified one or more sections are tagged across existing and new contract repositories using the Artificial Intelligence (AI) technique.

### CROSS REFERENCE TO RELATED APPLICATIONS

This application claims priority to and the benefit of the provisional patent application number 202041035209 titled “System and method for extracting data form contracts using AI based natural language processing (NLP)” filed in the Indian Patent Office on Sep. 15, 2020. The specification of the above referenced patent application is incorporated herein by reference in its entirety.

### BACKGROUND

### Technical Field

The proposed invention uses AI based Natural Language Processing (NLP) to extract data and insights from contracts into meaningful actions for customers.

### Description of the Related Art

A contract is a legally binding document that recognizes and governs the rights and duties of the parties to the agreement. Normally, contracts are either typically hand-written document or computer based digital representation of a written document. Contracts are complex documents having heterogeneous information. For example, the contracts may include legal terms, definitions, clauses, rights and obligations.

There are several electronic means to extract information from a contract. However, due to the complex nature of the contracts, these electronics means are not capable of extracting the accurate information from Contracts. So, Contracts have to be manually read and understood to extract meaningful insights.

Therefore, there is a need for a system and method to extract data and insights from contracts which then can be used as an enabler for decision making process.

### SUMMARY

In view of a foregoing, an embodiment herein provides a method for extracting data from contracts using a contract data extraction system. The method includes following steps of: obtaining a contract from which the data to be extracted; processing the contract to identify one or more sections of the contract; scanning for data within the identified one or more sections of the contract; and identifying and extracting the data from the corresponding one or more sections of the contract using natural language processing (NLP). The one or more sections include at least one of clauses, obligations, signature, and tabular data. The one or more sections are identified using a predefined library. The identified one or more sections are demarcated by matching with the predefined library. The identified one or more sections are tagged across existing and new contract repositories using the Artificial Intelligence (AI) technique. The contract data extraction system analyzes the section, which needs to be looking for based on the data to be extracted.

In an embodiment, the method further includes analyzing and comparing the extracted data from the corresponding one or more sections of the contract with data from another sources to derive required insights. Another sources include at least one of finance, enterprise resource planning (ERP) or customer relationship management (CRM).

In another embodiment, the method further includes steps of creating library of templates, clauses and defining approval workflows for each of these templates and business cases; and uploading third party contracts received from customers and comparing the third-party contracts against native templates for deviations.

In yet another embodiment, the data extracted from the one or more sections includes at least one of start date and end date of contracts, renewal terms, a name of parties in contract, jurisdiction and terms of payment.

In yet another embodiment, the contract data extraction system extracts the obligations including at least one of responsibilities, warranties, force Majeure, commercial terms, pricing, quality, change management, service level agreements (SLAs) and penalties, termination requirements. The contract data extraction system creates automatic tasks and assigns the automatic tasks to respective teams with SLAs.

In one aspect, a contract data extraction system for extracting data from contracts is provided. The contract data extraction system includes a processor and a memory. The memory is coupled to the processor. The memory includes instructions executable by the processor. The processor is configured to (i) obtain a contract from which the data to be extracted; (ii) process the contract to identify one or more sections of the contract; (iii) scan for data within the identified one or more sections of the contract; and (iv) identify and extract the data from the corresponding one or more sections of the contract using natural language processing (NLP). The one or more sections include at least one of clauses, obligations, signature, and tabular data. The one or more sections are identified using a predefined library. The identified one or more sections are demarcated by matching with the predefined library. The identified one or more sections are tagged across existing and new contract repositories using the Artificial Intelligence (AI) technique. The contract data extraction system analyzes the section, which needs to be looking for based on the data to be extracted

In an embodiment, the processor is further configured to analyze and compare the extracted data from the corresponding one or more sections of the contract with data from another sources to derive required insights. Another sources include at least one of finance, enterprise resource planning (ERP) or customer relationship management (CRM).

In another embodiment, the processor is configured to create library of templates, clauses and defining approval workflows for each of these templates and business cases; and upload third party contracts received from customers and compare the third-party contracts against native templates for deviations.

In yet another embodiment, the processor is further configured to provide details including at least one of approvers, clauses, obligations, deviations, version history, amendments, comments and related contracts relevant to the contract in one window using Contract 360.

In yet another embodiment, the processor is further configured to edit the contracts directly in word using the Microsoft Word Plugin.

The contract data extraction system avoids manual process for volumes to be time efficient and improve accuracy using AI and NLP. The contract data extraction system is easy to use, faster to implement, ability to extract metadata from volumes of contracts and help customers make informed faster decisions. The AI implemented in the contract data extraction system is performed as a micro-service and the AI may be implemented using Python, which enables the contract data extraction system to deal with the contracts of various formats including scanned images. Further, the contract data extraction system utilizes many open source libraries and own algorithms to achieve the data extraction. The contract data extraction system utilizes contract segmentation algorithm that ensures a more localized context for models, which has led to increased model performance. The segmentation algorithm takes a balanced approach that involves intelligence as well as domain knowledge.

The contract data extraction system enhances the existing data extraction models, which helps for the specific use cases (e.g. key metadata and risk parameters). Further, the contract data extraction system extracts the data from the contracts by utilizing expertise of legal professionals to ensure that the system/model captures the right information. The contract data extraction system can be improved or enhanced over time with the help of more and more data, validated by users and legal experts. The system includes task-specific logical layers and each layer is carefully devised to ensure that the user sees only the most relevant information. This involves trimming down text strings, or obtaining the best interpretation of the results. The contract data extraction system can search the one or more sections in the contract repositories using the natural language processing (NLP) in seconds instead of going through piles of contract folders.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a system for extracting data from contracts using a contract data extraction system according to an embodiment herein;

FIG. 2 is an exploded view of the contract data extraction system of FIG. 1 according to an embodiment herein;

FIG. 3 is a flow diagram illustrating a computer implemented method for extracting data from contracts using the contract data extraction system of FIG. 1 according to an embodiment herein; and

FIG. 4 illustrates a schematic diagram of a computing environment of a system used according to an embodiment herein.

### DETAILED DESCRIPTION OF PREFERRED EMBODIMENTS

The embodiments herein, the various features, and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

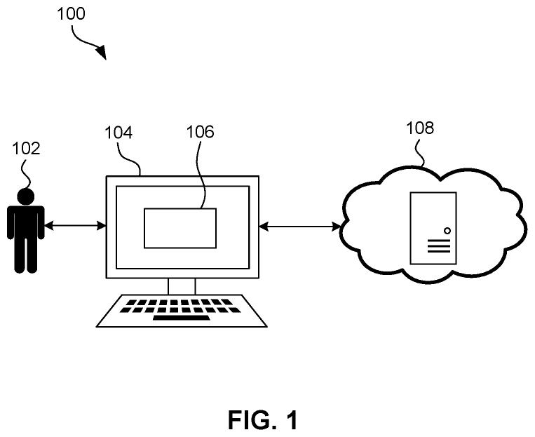

Various embodiments of the method and system disclosed herein provide a contract data extraction system for extracting data from contracts. The contract data extraction system is a cloud based software as a service (SaaS) offering that address entire cycle of contract lifecycle from creating/authoring contracts, negotiation, executing contracts and post contract management. The contract data extraction system allows to create and manage buy side, sell side and internal/corporate contracts. The contract data extraction system also provides ability to upload third party templates and executed contracts to perform contract management functionalities. The system provides reporting capabilities through powerful business intelligence (BI) features. The system can be integrated with customer relationship management (CRM), enterprise resource planning (ERP) as part of implementation service. Referring now to the drawing, and more particularly to FIGS. 1 through 4, where similar reference characters denote corresponding features consistently throughout the figures, there are shown preferred embodiments.

Definitions:

Natural Language Processing (NLP): Natural language processing helps computers communicate with humans in their own language and scales other language-related tasks. For example, NLP makes it possible for computers to read text, hear speech, interpret it, measure sentiment and determine which parts are important.

Artificial Intelligence (AI): Artificial intelligence is intelligence demonstrated by machines, as opposed to the natural intelligence displayed by humans or animals. AI Technique is a manner to organize and use the knowledge efficiently in such a way that it should be perceivable by the people who provide it. It should be easily modifiable to correct errors. It should be useful in many situations though it is incomplete or inaccurate.

FIG. 1 is a system 100 for extracting data from contracts using a contract data extraction system 106 according to an embodiment herein. The system 100 includes a user 102, a user device 104, the contract data extraction system 106 and a cloud storage 108. The user 102 is interacted with the user device 104 for extracting the data from contracts stored in the user device 104. In an embodiment, the contract data extraction system 106 is installed in the user device 104. In another embodiment, the contract data extraction system 106 may extract the data from contracts received from the cloud storage 108.

The contract data extraction system 106 obtains a contract from which the data to be extracted. The contract data extraction system 106 further processes the contract to identify one or more sections of the contract. In an embodiment, the one or more sections include at least one of clauses, obligations, signature, tabular data that includes key tables extracted from annexures/schedules (e.g. rate cards) and/or risk parameters that include key risk parameters such as non-compete and non-solicitation etc. In an embodiment, the one or more sections are identified using a predefined library. The identified one or more sections are demarcated by matching with the predefined library. The identified one or more sections are tagged across existing and new contract repositories using the Artificial Intelligence (AI) technique.

The contract data extraction system 106 scans the identified one or more sections to analyze the data (i.e. key metadata) within the identified one or more sections. The key metadata may include at least one of start date and end date of contracts, renewal terms, names of parties in contract, jurisdiction and terms of payment. In an embodiment, the contract data extraction system 106 analyzes the section which needs to be looking for based on the data to be extracted. The contract data extraction system 106 further identifies and extracts the data from the corresponding one or more sections of the contract using natural language processing (NLP).

The contract data extraction system 106 extracts the data from contracts using the natural language processing with below example scenario. When the contract is ingested/obtained into the user device 104, the user 102 wants to know the termination notice period mentioned in the contract. As next, the NLP skims through the contract to initially identify the different clauses including but not limited to term, termination, confidentiality etc. using predefined models. The NLP (a) determines the clauses, (b) tags the clauses and (c) marks the clauses with a start and end so that the user 102 can identify where each clause starts and ends in a large contract document. Using the NLP, the user 102 identifies whether there is a termination clause present in the contract when the clauses are tagged. The termination may be called by any corresponding synonym. The contract data extraction system 106 may track the same meaningful phrase for the termination.

The user 102 knows the notice period for the termination within the termination clause when the user 102 identifies the clause (i.e. the user 102 identifies the clause to analyze and locate the notice period for the termination using the NLP). In some instances, the notice period is given directly (e.g. 30 days or 60 days prior termination), but at times the notice period is indirect (e.g. 1 month before the expiry date of the contract). In these scenario, the NLP in the contract data extraction system 106 interprets the language of the contract, determines the expiry date and calculates for arriving at the exact date by when a notice needs to be issued in case of a termination. In an embodiment, the above analysis using the NLP can be done for extracting non-compete, expiry date, effective date and jurisdiction etc.

In an embodiment, the user 102 is a customer who wants to extract the data from contracts. In an embodiment, the user device 104 may be a personal computer, a mobile phone, a Smartphone, a tablet, an electronic notebook etc.

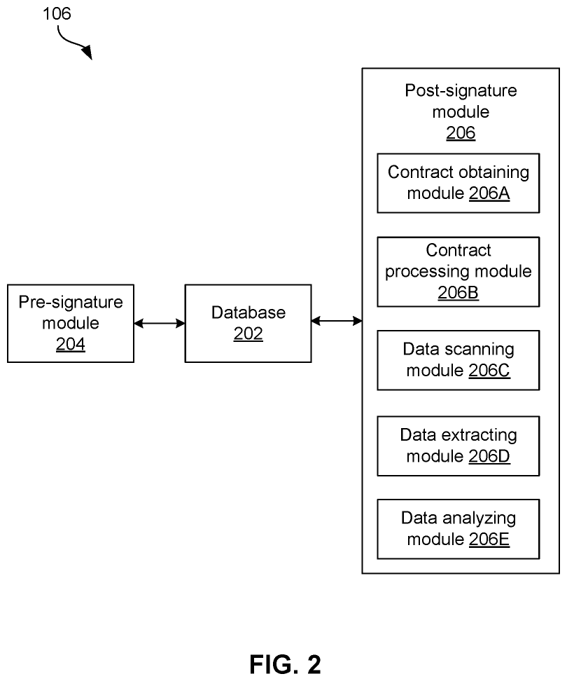

FIG. 2 is an exploded view 200 of the contract data extraction system 106 of FIG. 1 according to an embodiment herein. The contract data extraction system 106 includes a data base 202, a pre-signature module 204 and a post-signature module 206. The database 202 is a storage that stores relevant information of the contracts from which the data to be extracted. The pre-signature module 204 creates library of templates, clauses and define approval workflows for each of the templates and business cases. The pre-signature module 204 provides an option to upload third party contracts received from customers and compare the third party contracts against native templates for deviations. The pre-signature module 204. includes Contract 360 window that provides information relevant to the contract in a single window (e.g. approvers, clauses, obligations, deviations, version history, amendments, comments and related contracts etc.)

The pre-signature module 204 further provides ability to (a) index and store contracts, (b) retrieve and search the contracts from repository and (c) integrate the contracts with source to procure/CRM systems. In an embodiment, the pre-signature module 204 includes a Microsoft Word Plugin that allows to edit the contracts from the user device 104 directly in word. Further, the Microsoft Word Plugin accesses the clause libraries and compares clauses directly in word. For instance, the version of the Microsoft Word Plugin flows automatically into the user device 104 implementing the contract data extraction system 106 as a new version with red lining and the changes are explicitly captured between versions for easier comparison when the contract is saved in word. Further, the pre-signature module 204 includes options such as reports and dashboards for creating and providing customizable reports for legal, sales, procurement teams.

The post-signature module 206 extracts key fields such as start date and end date of the contracts, renewal terms, parties in contract, jurisdiction, terms of payment etc. The post-signature module 106 may extract the key fields form all contract types including old contracts and the uploaded third party contracts. The post-signature module 206 includes a contract obtaining module 206A, a contract processing module 206B, a data scanning module 206C, a data extracting module 206D and a data analyzing module 206E.

The contract obtaining module 206A obtains a contract from which the data to be extracted. In an embodiment, the contract may be received from the cloud storage 108. The contract processing module 206B processes the contract to identify one or more sections (e.g. key clauses) of the contract. The one or more sections include at least one of clauses, obligations, signature, tabular data that includes key tables extracted from annexures/schedules (e.g. rate cards) and/or risk parameters that include key risk parameters such as non-compete and non-solicitation etc. The contract processing module 206B demarcates the one or more sections by matching the one or more sections with the predefined library of templates related to the one or more sections. Further, the contract processing module 206B tags the one or more sections across existing and new contract repositories using the Artificial Intelligence (AI) technique.

The data scanning module 206C scans for data within the identified one or more sections of the contract. The contract data extraction system 106 analyzes the section, which needs to be looking for based on the data to be extracted. The data extracting module 206D identifies and extracts the data from the corresponding one or more sections of the contract using natural language processing (NLP). The data analyzing module 206E analyzes and compares the extracted data from the corresponding one or more sections of the contract with data from another sources to derive required insights. In an embodiment, another sources include at least one of finance, enterprise resource planning (ERP) or customer relationship management(CRM).

In an embodiment, the one or more sections include data related to obligations that include at least one of responsibilities, warranties, force Majeure, commercial terms, pricing, quality, change management, service level agreements (SLAs) and penalties, termination requirements. Further, the contract data extraction system 106 creates automatic tasks and assigns the automatic tasks to respective teams with SLAs. In an embodiment, the contract data extraction system 106 maps the extracted data to the contextual data points in order to extract the tabular data.

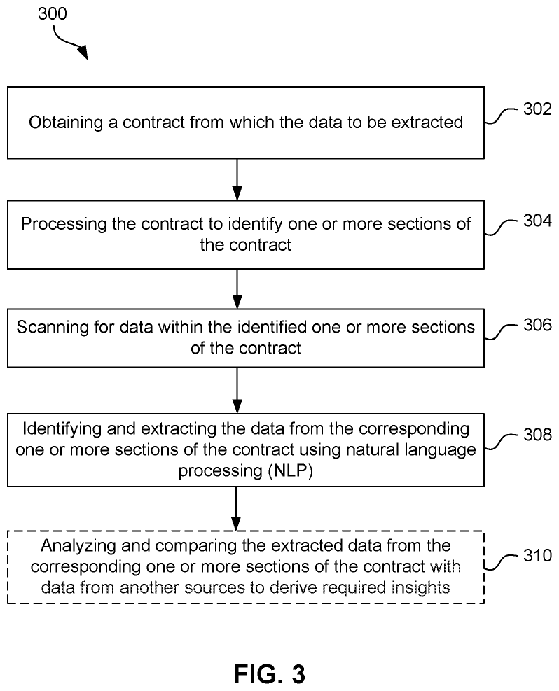

FIG. 3 is a flow diagram illustrating a computer implemented method 300 for extracting data from contracts using the contract data extraction system 106 of FIG. 1 according to an embodiment herein. In step 302, a contract from which the data to be extracted using the contract obtaining module 206A. In an embodiment, the data is extracted from the contract stored at local storage or cloud storage 108. In step 304, the contract, using the contract processing module 206B, is processed to identify one or more sections (e.g. identification of key clauses) of the contract. In an embodiment, the identified one or more sections are demarcated by matching with the predefined library. In another embodiment, the identified one or more sections are tagged across existing and new contract repositories using the Artificial Intelligence (AI) technique.

In step 306, the identified one or more sections, using the data scanning module 206C, are scanned for the data to be extracted. In an embodiment, the section is analyzed by the contract data extraction system 106, in which the section needs to be looking for based on the data to be extracted. In step 308, the data, using the data extracting module 206D, is identified and extracted from the corresponding one or more sections of the contract using natural language processing (NLP). In step 310, the extracted data from the corresponding one or more sections of the contract is analyzed and compared with data from another sources to derive required insights using the data analyzing module 206E. In an embodiment, another sources include at least one of finance, enterprise resource planning (ERP) or customer relationship management (CRM).

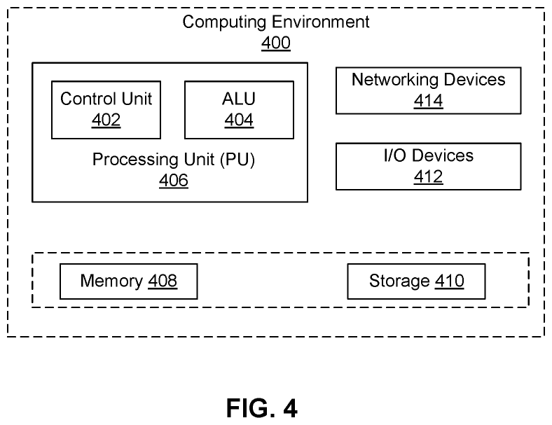

FIG. 4 illustrates an example computing environment 400 implementing a method 300 and the system 100 including the user device 104 for extracting the data from contracts as described in FIGS. 1 and 3. As depicted in FIG. 4, the computing environment 400 of the system 100/the user device 104 includes at least one data processing unit 406 that is equipped with a control unit 402 and an Arithmetic Logic Unit, ALU 404, a memory 408, a storage 410, plurality of networking devices 414 and a plurality Input output, I/O devices 412. The data processing unit 406 is responsible for processing the instructions of the algorithm. For example, the data processing unit 406 is equivalent to the processor of the system 100/the user device 104. The data processing unit 406 is capable of executing software instructions stored in memory 408. The data processing unit 406 receives commands from the control unit 402 in order to perform its processing. Further, any logical and arithmetic operations involved in the execution of the instructions are computed with the help of the ALU 404.

The computer program is loadable into the data processing unit 406, which may, for example, be included in an electronic apparatus (such as the system 100//the user device 104). When loaded into the data processing unit 406, the computer program may be stored in the memory 408 associated with or included in the data processor. According to some embodiments, the computer program may, when loaded into and run by the data processing unit 406, cause execution of method steps according to, for example, the method illustrated in FIG. 3 or otherwise described herein

The overall computing environment 400 may be composed of multiple homogeneous and/or heterogeneous cores, multiple CPUs of different kinds, special media and other accelerators. The data processing unit 406 is responsible for processing the instructions of the algorithm. Further, the plurality of data processing units 406 may be located on a single chip or over multiple chips.

The algorithm including of instructions and codes required for the implementation are stored in either the memory 408 or the storage 410 or both. At the time of execution, the instructions may be fetched from the corresponding memory 408 and/or storage 410, and executed by the data processing unit 406.

In case of any hardware implementations various networking devices 414 or external I/O devices 412 may be connected to the computing environment to support the implementation through the networking devices 414 and the I/O devices 412.

The embodiments disclosed herein can be implemented through at least one software program running on at least one hardware device and performing network management functions to control the elements. The elements shown in FIG. 4 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method for extracting data from contracts using a contract data extraction system, the method comprising:
obtaining a contract from which the data to be extracted;
processing the contract to identify one or more sections of the contract, wherein the one or more sections comprise at least one of clauses, obligations, signature, and tabular data, wherein the one or more sections are identified using a predefined library, wherein the identified one or more sections are demarcated by matching with the predefined library, wherein the identified one or more sections are tagged across existing and new contract repositories using the Artificial Intelligence (AI) technique;
scanning for data within the identified one or more sections of the contract, wherein the contract data extraction system analyzes the section, which needs to be looking for based on the data to be extracted; and
identifying and extracting the data from the corresponding one or more sections of the contract using natural language processing (NLP).

2. The method of claim 1, the method comprising analyzing and comparing the extracted data from the corresponding one or more sections of the contract with data from another sources to derive required insights, wherein the another sources comprise at least one of finance, enterprise resource planning (ERP) or customer relationship management (CRM).

3. The method of claim 1, the method comprising:
creating library of templates, clauses and defining approval workflows for each of these templates and business cases; and
uploading third party contracts received from customers and comparing the third party contracts against native templates for deviations.

4. The method of claim 1, wherein the data extracted from the one or more sections comprises at least one of start date and end date of contracts, renewal terms, names of parties in contract, jurisdiction and terms of payment.

5. The method of claim 1, wherein the contract data extraction system extracts the obligations comprising at least one of responsibilities, warranties, force Majeure, commercial terms, pricing, quality, change management, service level agreements (SLAB) and penalties, termination requirements and wherein the contract data extraction system creates automatic tasks and assigns the automatic tasks to respective teams with SLAs.

6. A contract data extraction system for extracting data from contracts, the contract data extraction system comprising:
a processor; and
a memory coupled to the processor, the memory comprising instructions executable by the processor, wherein the processor is configured to:
obtain a contract from which the data to be extracted;
process the contract to identify one or more sections of the contract, wherein the one or more sections comprise at least one of clauses, obligations, signature, and tabular data, wherein the one or more sections are identified using a predefined library, wherein the identified one or more sections are demarcated by matching with the predefined library, wherein the identified one or more sections are tagged across existing and new contract repositories using the Artificial Intelligence (AI) technique;
scan for data within the identified one or more sections of the contract, wherein the contract data extraction system analyzes the section, which needs to be looking for based on the data to be extracted; and
identify and extract the data from the corresponding one or more sections of the contract using natural language processing (NLP).

7. The contract data extraction system of claim 6, wherein the processor is configured to analyze and compare the extracted data from the corresponding one or more sections of the contract with data from another sources to derive required insights, wherein the another sources comprise at least one of finance, enterprise resource planning (ERP) or customer relationship management (CRM).

8. The contract data extraction system of claim 6, wherein the process is configured to:
create library of templates, clauses and defining approval workflows for each of these templates and business cases; and
upload third party contracts received from customers and compare the third party contracts against native templates for deviations.

9. The contract data extraction system of claim 6, wherein the processor is configured to provide details comprising at least one of approvers, clauses, obligations, deviations, version history, amendments, comments and related contracts relevant to the contract in one window using Contract 360.

10. The contract data extraction system of claim 6, wherein the processor is configured to edit the contracts directly in word using the Microsoft Word Plugin.

11. A non-transitory computer readable recording medium storing a computer program product for extracting data from contracts, the computer program product comprising software instructions which, when run on processing circuitry of a device, causes the device to:
obtain a contract from which the data to be extracted;
process the contract to identify one or more sections of the contract, wherein the one or more sections comprise at least one of clauses, obligations, signature, and tabular data, wherein the one or more sections are identified using a predefined library, wherein the identified one or more sections are demarcated by matching with the predefined library, wherein the identified one or more sections are tagged across existing and new contract repositories using the Artificial Intelligence (AI) technique;
scan for data within the identified one or more sections of the contract, wherein the contract data extraction system analyzes the section, which needs to be looking for based on the data to be extracted; and
identify and extract the data from the corresponding one or more sections of the contract using natural language processing (NLP).
